(19) United States
(12) Patent Application Publication
(10) Pub. No.: US 2009/0294007 A1
(43) Pub. Date: Dec. 3, 2009

(54) PERFORMANCE TIRE WITH SIDEWALL INSERT

(76) Inventor: Walter Vorreiter, Somborn (DE)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/465,916

(22) Filed: May 14, 2009

Related U.S. Application Data
(60) Provisional application No. 61/057,896, filed on Jun. 2, 2008.

(51) Int. Cl. B60C 13/04

(52) U.S. Cl. 152/524

(57) ABSTRACT

A pneumatic tire is provided having a carcass with at least one carcass ply, an innerliner, a sidewall, a bead comprising a bead core and a bead apex, and a tread disposed radially outward of the carcass, The sidewall has only a single crescent-shaped rubber insert located between the innerliner and the at least one carcass ply. The rubber of the at least one crescent-shaped rubber insert has a hardness (Shore A, 100° C.) in a range of about 68 to about 90, and the maximum thickness of the at least one crescent-shaped rubber insert, as measured parallel to the axis of rotation of the tire, is less than 30% of the thickness of the tire sidewall as measured parallel to the axis of rotation of the tire from the axially inner surface of the innerliner to the axially outer surface of the sidewall at the location of the maximum thickness of the rubber insert.

This application claims the benefit of Ser. No. 61/057,896 filed on Jun. 2, 2008.

### TECHNICAL FIELD

This invention relates to pneumatic tires, and more particularly to high performance passenger tires that are not runflat.

### BACKGROUND OF THE INVENTION

For modern high performance passenger tires, it is highly desired to have superior handling, especially cornering stability. It is known in the runflat tire art to utilize sidewall designs that are thicker and/or stiffer, so that the tire's load can be carried by an uninflated tire without otherwise compromising vehicle handling until such reasonable time as the tire can be repaired or replaced. The methods used in sidewall stiffening include the incorporation of inserts or fillers generally having, in cross-sectional view, a crescent shape. Such inserts or fillers are located in the inner peripheral surface of the sidewall portion of the carcass, which is the region in the tire usually having the lowest rigidity. In such runflat tire designs, the entire sidewall has a crescent shaped cross-section so as to provide rigidity. The sidewalls of such tires, when operated in the uninflated condition, experience a net compressive load, though with outer portions of the sidewalls necessarily being in tension due to the bending deformation, especially in the regions of the sidewall adjacent to the ground-contacting portion of the tread. Due to the large amounts of rubber required to stiffen the sidewall members, heat buildup is a major factor in tire failure especially when the uninflated tire is operated for prolonged periods at high speeds. These inserts are typically located between the carcass plys.

### BRIEF DESCRIPTION OF THE DRAWINGS

The structure, operation, and advantages of the presently preferred embodiment of the invention will become further apparent upon consideration of the following description taken in conjunction with the accompanying drawings, wherein:

FIG. 1 is a cross-sectional view of a tire of the present invention;

### DEFINITIONS

“Aspect Ratio” means the ratio of the section height of a tire to its section width.

“Axial” and “axially” means the lines or directions that are parallel to the axis of rotation of the tire.

“Bead” or “Bead Core” generally means that part of the tire comprising an annular tensile member of radially inner beads that are associated with holding the tire to the rim; the beads being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Carcass” means the tire structure apart from the belt structure, tread, undertread over the plies, but including the beads.

“Casing” means the carcass, belt structure, beads, sidewalls and all other components of the tire excepting the tread and undertread.

“Circumferential” means lines or directions extending along the perimeter of the surface of the annular tread perpendicular to the axial direction.

“Cord” means one of the reinforcement strands of which the plies in the tire are comprised.

“Equatorial Plane” means the plane perpendicular to the tire's axis of rotation and passing through the center of its tread.

“Innerliner” means the layer or layers of elastomer or other material that form the inside surface of a tubeless tire and that contain the inflating gas within the tire.

“Lateral” means a direction parallel to the axial direction.

“Normal Inflation Pressure” means the specific design inflation pressure and load assigned by the appropriate standards organization for the service condition for the tire.

“Ply” means a layer of rubber-coated parallel cords.

“Radial” and “radially” mean directions radially toward or away from the axis of rotation of the tire.

“Radial Ply Structure” means the one or more carcass plies of which at least one ply has reinforcing cords oriented at an angle of between 65 degrees and 90 degrees with respect to the equatorial plane of the tire.

“Radial Ply Tire” means a belted or circumferentially-restricted pneumatic tire in which at least one ply has cords that extend from bead to bead and are laid at cord angles between 65° and 90° with respect to the equatorial plane of the tire.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal inflation pressure for 24 hours, but unloaded, excluding elevations of the sidewalls due to labeling, decoration or protective bands.

“Shoulder” means the upper portion of sidewall just below the tread edge.

“Sidewall” means that portion of a tire between the tread and the bead.

### DETAILED DESCRIPTION OF THE PREFERRED EMBODIMENT

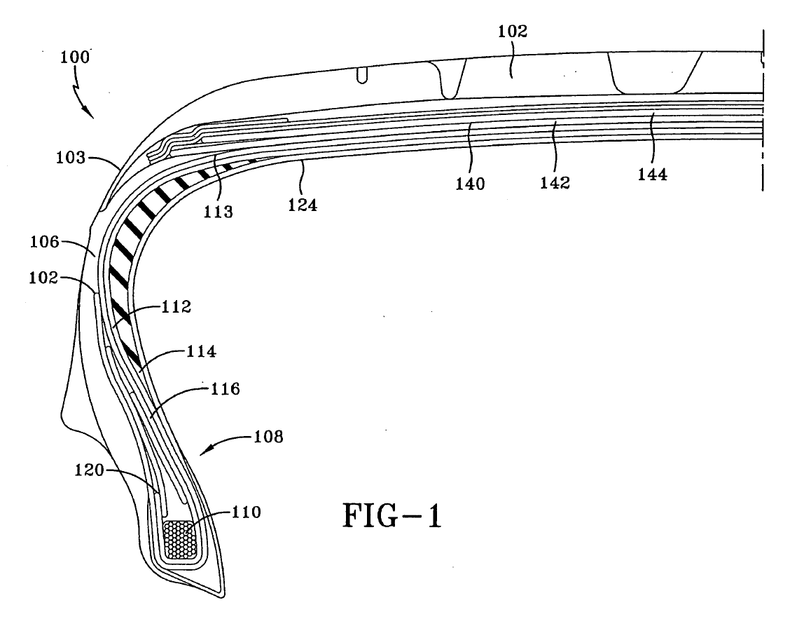

With reference to FIG. 1, a cross section of a pneumatic radial tire 100 for use in passenger vehicles is illustrated. The tire 100 is a passenger tire, preferably a high performance tire. The tire may or not be a run-flat tire. The tire 100 has a ground-engaging tread portion 102 which terminates in the shoulder portions 103 at the lateral edges of the tread portion. The tire further includes sidewall portions 106 which extend from the lateral edges of the tread portion and terminate in the respective bead regions 108, each having an annular inextensible bead core 110. The tire 100 is further provided with a carcass reinforcing structure 112 which extends across the entire tire structure from bead region through one sidewall portion 106, tread portion, opposite sidewall portion to bead region. The carcass reinforcing structure is preferably radial and comprises one or more plies, preferably two plies 114 and 116. The turnup ends 118 or 120 of at least one ply 114 or 116 of radial ply structure are wrapped about bead cores 110 on each side of the tire. Preferably the plys 114,116 are nonmetallic.

Preferably, at least one turnup end 120, and most preferably turnup ends 120 and 122 are wrapped about the bead cores. The tire 10 may include a conventional innerliner 124 forming the inner peripheral surface of the tire 100 if the tire is to be of the tubeless type.

Placed circumferentially about the radially outer surface of carcass reinforcing structure and beneath the tread portion is a tread reinforcing belt structure 140. In the particular embodiment illustrated, belt structure 140 comprises two cut belt plies 142,144. The cords of belt plies 142,144 are oriented at an angle of about 15 degrees to about 35 degrees and preferably about 20 degrees to about 28 degrees with respect to the mid-circumferential centerline (C/L) of the tire. However, the belt structure 140 may comprise any number of belt plies of any desired configuration and of an orientation within a range of about 0 degrees to about 90 degrees. The belt structure 140 provides lateral stiffness across the belt width so as to minimize lifting of the tread from the road surface during operation of the tire in the uninflated condition. In the embodiments illustrated, the lateral stiffness is accomplished by making the cords of belt plies of fiberglass, aramid and/or metal and preferably of steel and more preferably of a steel cable construction.

The first and second reinforcing ply structures each comprises a single ply layer. It is, however, within the terms of the present invention to include any number of additional reinforcing ply structures in such locations as to be axially outward of steel reinforced ply structure.

### Sidewall Insert

The tire further includes only a single insert 42 located axially inward of the one or more plies, between the innerliner and the plies, and in the flex area of each sidewall. Each insert 42 extends from each bead region 108, which includes the beads 110 and the apex 48, radially to beneath the reinforcing belt structures 140 in each sidewall. Preferably, the end of the insert radially overlaps with the radially outer end of the apex. The insert 42 is located between the innerliner and the plies.

The single insert in each sidewall is preferably made of elastomeric material. The elastomeric material of insert can be selected from a wide range of elastomers having shore A hardnesses from a relative soft shore A of about 60 to very hard 90. More preferably, the shore A hardness (100° C.) ranges from about 70 to about 90, and more preferably from about 75 to 90, and most preferably from about 80 to about 90. The insert shape, which is illustrated as having a crescent shaped cross-sectional profile, can be modified to insure good ride performance and an acceptable sidewall spring rate. The elastomeric compound has a tangent delta in the range of between about 0.02 to 0.06 and has a modulus G between about 2 MPa and about 8 Mpa (as measured at Metravib at 90° C., 0.2%).

An important aspect in selecting the elastomeric material for insert 42 is hysteresis. The hysteresis of the elastomeric material is a measure of its tendency to generate internal heat under flexing service conditions. Hysteresis is a term for heat energy expended in a material (e.g., cured rubber composition) by applied work, and low hysteresis of a rubber composition is indicated by a relatively high rebound, relatively low internal friction and relatively low loss modulus property values. Relatively speaking, a rubber or elastomeric material having a lower hysteresis generates less internal heat under service conditions than an otherwise comparable elastomeric or rubber with a substantially higher hysteresis. Thus, a relatively low hysteresis is desired for the rubber composition for the insert 42 and the plycoat(s) of plies 38 and 40.

In particular, for the purposes of this invention, the aforesaid sidewall insert 42 preferably has a high degree of stiffness yet also a relatively low hysteresis. This further reduces the heat-generating effects of flexure of insert 42, especially when the tire is operated under underinflated or runflat conditions. The tire's life, especially during runflat operation, is thereby improved over that of prior art runflat tires.

Generally, the stiffness of the rubber composition for insert 42 is desirable for strength and dimensional stability of the tire sidewall. Accordingly, it is important that the rubber or elastomeric compositions for inserts 42 and the plycoats of plies 38 and 40 have the properties of both relatively high stiffness and low hysteresis.

While the invention has been described in combination with embodiments thereof, it is evident that many alternatives, modifications, and variations will be apparent to those skilled in the art in light of the foregoing teachings. Accordingly, the invention is intended to embrace all such alternatives, modifications and variations as fall within the spirit and scope of the appended claims.

What is claimed:

1. A pneumatic tire comprising a carcass having at least one carcass ply, an innerliner, a sidewall, a bead comprising a bead core and a bead apex, and a tread disposed radially outward of the carcass, wherein the sidewall comprises only a single crescent-shaped rubber insert located between the innerliner and the at least one carcass ply, wherein the rubber of the at least one crescent-shaped rubber insert has a hardness (Shore A, 100° C.) in a range of about 68 to about 90, and wherein the maximum thickness of the at least one crescent-shaped rubber insert, as measured parallel to the axis of rotation of the tire, is less than 30% of the thickness of the tire sidewall as measured parallel to the axis of rotation of the tire from the axially inner surface of the innerliner to the axially outer surface of the sidewall at the location of the maximum thickness of the rubber insert.

2. The tire of claim 1 comprising only one single crescent-shaped rubber insert.

3. The tire of claim 1 wherein the maximum thickness is less than 20% of the thickness of the tire sidewall.

4. The tire of claim 1 wherein the maximum thickness is about 15% to about 25% of the thickness of the tire sidewall.

5. The tire of claim 1 wherein the maximum thickness of the one or more crescent-shaped rubber insert(s) is less than 3 mm.

6. The tire of claim 1 wherein the maximum thickness of the one or more crescent-shaped rubber insert(s) is from 1.5 to 2.5 mm

7. The tire of claim 1 comprising two carcass plies that both extend from one bead of the tire to the other bead of the tire and that are both wrapped around a respective bead core from the axially inner side to the axially outer side of said bead core, wherein the end of the axially inner carcass ply turn-up is located at a radial height of 10 to 30 mm, alternatively 15 to 25 mm, as measured radially upwards from a line parallel to the radially lower side of the bead core, and wherein the end of the axially outer carcass ply turn-up is located at a radial height of 35 to 65, alternatively 45 to 55 mm, as measured radially upwards from a line parallel to the radially lower side of the bead core.

8. The tire of claim 1 wherein a radially upper tip of the bead apex is located at a radial height of 20 to 35 mm, alternatively 25 to 30 mm, as measured radially upwards from a line parallel to the radially lower side of the bead core.

9. The tire of claim 1 wherein the hardness (Shore A, 100° C.) is in a range of from 74 to 80.

10. The tire of claim 1 wherein the hardness (Shore A, 100° C.) is in a range of from 76 to 78.

11. The tire of claim 1 wherein the at least one crescent-shaped rubber insert extends from a radial height of 20 to 35 mm, alternatively 25 to 30 mm, as measured radially upwards from a line parallel to the radially lower side of the bead core, through the sidewall up to under the tread of the tire.

12. The tire of claim 1 wherein the at least one crescent-shaped rubber insert extends axially inwardly under the tread over a lateral distance of 15 to 30 mm, as measured a respective lateral outer tread edge parallel to the axial direction of the tire.
